(19) United States
(12) Patent Application Publication
(10) Pub. No.: US 2025/0350411 A1
(43) Pub. Date: Nov. 13, 2025

(54) EXTENDED PREAMBLE FOR REMOTE-TO-DEVICE COMMUNICATIONS

(71) Applicant: QUALCOMM Incorporated, San Diego, CA (US)

(72) Inventors: Ahmed Abdelaziz Ibrahim Abdelaziz ZEWAIL, San Diego, CA (US); Zhifei FAN, San Diego, CA (US); Chengjin ZHANG, San Diego, CA (US); Piyush GUPTA, Bridgewater, NJ (US)

(21) Appl. No.: 19/189,121

(22) Filed: Apr. 24, 2025

Related U.S. Application Data
(60) Provisional application No. 63/644,823, filed on May 9, 2024.

(51) Int. Cl. H04L 5/00

(52) U.S. Cl. CPC H04L 5/0005

(57) ABSTRACT

Methods, systems, and devices for wireless communications are described. For example, an ambient internet of things (A-IoT) device may receive an extended preamble that includes dummy resources to enhance preamble detection. An RF reader may extend a preamble of a forward link with one or more dummy samples or one or more dummy symbols to compensate for a local clock error of the A-IoT device. In some examples, the extended preamble transmission may be preceded by a continuous wave transmission (e.g., a wireless power charging signal). In such examples, the A-IoT device may receive an automatic gain control (AGC) value in the extended preamble. The AGC value may enable the A-IoT device to adjust a comparator threshold for receiving information in the forward link.

### CROSS REFERENCE

The present Application for Patent claims the benefit of U.S. Provisional Patent Application No. 63/644,823 by ZEWAIL et al., entitled “EXTENDED PREAMBLE FOR REMOTE-TO-DEVICE COMMUNICATIONS,” filed May 9, 2024, and assigned to the assignee hereof. U.S. Provisional Application 63/644,823 is expressly incorporated by reference herein in its entirety.

### INTRODUCTION

The following relates to wireless communications that pertain to remote-to-device communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDM A), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by an ambient internet-of-things (A-IoT) device is described. The method may include receiving, via a set of multiple time resources, a forward link transmission including an extended preamble, where the set of multiple time resources includes a first set of one or more boundary resources, a second set of one or more boundary resources, and a set of multiple intervening resources that are temporally between the first set of one or more boundary resources and the second set of one or more boundary resources, and where the extended preamble includes a base sequence with a start value and an end value, where the base sequence is included in the forward link transmission and is received via the set of multiple intervening resources, where the extended preamble includes a first set of one or more values received via the first set of one or more boundary resources and a second set of one or more values received via the second set of one or more boundary resources, where the first set of one or more values are based on the start value of the base sequence, and the second set of one or more values are based on the end value of the base sequence, extracting the base sequence from the extended preamble, and decoding a remainder of the forward link transmission based on extraction of the base sequence from the extended preamble.

An A-IoT device is described. The A-IoT device may include one or more memories storing processor executable code, and one or more processors coupled with the one or more memories. The one or more processors may individually or collectively be operable to execute the code to cause the A-IoT device to receive, via a set of multiple time resources, a forward link transmission including an extended preamble, where the set of multiple time resources includes a first set of one or more boundary resources, a second set of one or more boundary resources, and a set of multiple intervening resources that are temporally between the first set of one or more boundary resources and the second set of one or more boundary resources, and where the extended preamble includes a base sequence with a start value and an end value, where the base sequence is included in the forward link transmission and is received via the set of multiple intervening resources, where the extended preamble includes a first set of one or more values received via the first set of one or more boundary resources and a second set of one or more values received via the second set of one or more boundary resources, where the first set of one or more values are based on the start value of the base sequence, and the second set of one or more values are based on the end value of the base sequence, extract the base sequence from the extended preamble, and decode a remainder of the forward link transmission based on extraction of the base sequence from the extended preamble.

Another A-IoT device is described. The A-IoT device may include means for receiving, via a set of multiple time resources, a forward link transmission including an extended preamble, where the set of multiple time resources includes a first set of one or more boundary resources, a second set of one or more boundary resources, and a set of multiple intervening resources that are temporally between the first set of one or more boundary resources and the second set of one or more boundary resources, and where the extended preamble includes a base sequence with a start value and an end value, where the base sequence is included in the forward link transmission and is received via the set of multiple intervening resources, where the extended preamble includes a first set of one or more values received via the first set of one or more boundary resources and a second set of one or more values received via the second set of one or more boundary resources, where the first set of one or more values are based on the start value of the base sequence, and the second set of one or more values are based on the end value of the base sequence, means for extracting the base sequence from the extended preamble, and means for decoding a remainder of the forward link transmission based on extraction of the base sequence from the extended preamble.

A non-transitory computer-readable medium storing code is described. The code may include instructions executable by one or more processors to receive, via a set of multiple time resources, a forward link transmission including an extended preamble, where the set of multiple time resources includes a first set of one or more boundary resources, a second set of one or more boundary resources, and a set of multiple intervening resources that are temporally between the first set of one or more boundary resources and the second set of one or more boundary resources, and where the extended preamble includes a base sequence with a start value and an end value, where the base sequence is included in the forward link transmission and is received via the set of multiple intervening resources, where the extended preamble includes a first set of one or more values received via the first set of one or more boundary resources and a second set of one or more values received via the second set of one or more boundary resources, where the first set of one or more values are based on the start value of the base sequence, and the second set of one or more values are based on the end value of the base sequence, extract the base sequence from the extended preamble, and decode a remainder of the forward link transmission based on extraction of the base sequence from the extended preamble.

In some examples of the method, A-IoT devices, and non-transitory computer-readable medium described herein, the first set of one or more values includes one or more dummy values that immediately precede, and may be adjacent to, the start value of the base sequence and the one or more dummy values may be equal to the start value.

In some examples of the method, A-IoT devices, and non-transitory computer-readable medium described herein, the forward link transmission includes a continuous wave (CW) signal and the first set of one or more values includes an automatic gain control (AGC) value that immediately precedes, and may be adjacent to, the one or more dummy values.

In some examples of the method, A-IoT devices, and non-transitory computer-readable medium described herein, the AGC value may be different than the start value. Some examples of the method, ambient internets, and non-transitory computer-readable medium described herein may further include operations, features, means, or instructions for determining a baseline value for a digital high value or a digital low value based on the AGC value, where decoding the remainder may be based on the baseline value.

In some examples of the method, A-IoT devices, and non-transitory computer-readable medium described herein, the second set of one or more values includes one or more dummy values that immediately follow, and may be adjacent to, the end value of the base sequence and the one or more dummy values may be equal to the end value.

In some examples of the method, A-IoT devices, and non-transitory computer-readable medium described herein, the set of multiple time resources include orthogonal frequency-division multiplexing (OFDM) symbols, OFDM samples, or any combination thereof and the set of multiple intervening resources include a first set of one or more OFDM symbols, and the first set of one or more boundary resources and the second set of one or more boundary resources include respective sets of one or more OFDM symbols or respective portions of one or more OFDM symbols.

In some examples of the method, A-IoT devices, and non-transitory computer-readable medium described herein, the respective sets of one or more OFDM symbols or the respective portions of one or more OFDM symbols include one or more OFDM samples. In some examples of the method, ambient internets, and non-transitory computer-readable medium described herein, the one or more OFDM samples may be dummy samples.

In some examples of the method, A-IoT devices, and non-transitory computer-readable medium described herein, the forward link transmission includes Manchester encoded data and the Manchester encoded data immediately follows, and may be adjacent to, the second set of one or more values.

A method for wireless communication performed by a network entity is described. The method may include extending a base sequence, that includes a start value and an end value, into an extended preamble, where the extended preamble includes the base sequence, a first set of one or more values that precede the base sequence, and a second set of one or more values that follow the base sequence, and where the first set of one or more values are based on the start value of the base sequence, and the second set of one or more values are based on the end value of the base sequence and transmitting, via a set of multiple time resources, a forward link transmission including the extended preamble to an A-IoT device, where the set of multiple time resources includes a first set of one or more boundary resources, a second set of one or more boundary resources, and a set of multiple intervening resources that are temporally between the first set of one or more boundary resources and the second set of one or more boundary resources, and where the base sequence is included in the forward link transmission and transmitted via the set of multiple intervening resources, where the first set of one or more values are included in the forward link transmission and transmitted via the first set of one or more boundary resources, and the second set of one or more values are included in the forward link transmission and transmitted via the second set of one or more boundary resources.

A network entity for wireless communication performed is described. The network entity may include one or more memories storing processor executable code, and one or more processors coupled with the one or more memories. The one or more processors may individually or collectively be operable to execute the code to cause the network entity to extend a base sequence, that includes a start value and an end value, into an extended preamble, where the extended preamble includes the base sequence, a first set of one or more values that precede the base sequence, and a second set of one or more values that follow the base sequence, and where the first set of one or more values are based on the start value of the base sequence, and the second set of one or more values are based on the end value of the base sequence and transmit, via a set of multiple time resources, a forward link transmission including the extended preamble to an A-IoT device, where the set of multiple time resources includes a first set of one or more boundary resources, a second set of one or more boundary resources, and a set of multiple intervening resources that are temporally between the first set of one or more boundary resources and the second set of one or more boundary resources, and where the base sequence is included in the forward link transmission and transmitted via the set of multiple intervening resources, where the first set of one or more values are included in the forward link transmission and transmitted via the first set of one or more boundary resources, and the second set of one or more values are included in the forward link transmission and transmitted via the second set of one or more boundary resources.

Another network entity for wireless communication performed is described. The network entity may include means for extending a base sequence, that includes a start value and an end value, into an extended preamble, where the extended preamble includes the base sequence, a first set of one or more values that precede the base sequence, and a second set of one or more values that follow the base sequence, and where the first set of one or more values are based on the start value of the base sequence, and the second set of one or more values are based on the end value of the base sequence and means for transmitting, via a set of multiple time resources, a forward link transmission including the extended preamble to an A-IoT device, where the set of multiple time resources includes a first set of one or more boundary resources, a second set of one or more boundary resources, and a set of multiple intervening resources that are temporally between the first set of one or more boundary resources and the second set of one or more boundary resources, and where the base sequence is included in the forward link transmission and transmitted via the set of multiple intervening resources, where the first set of one or more values are included in the forward link transmission and transmitted via the first set of one or more boundary resources, and the second set of one or more values are included in the forward link transmission and transmitted via the second set of one or more boundary resources.

A non-transitory computer-readable medium storing code for wireless communication performed is described. The code may include instructions executable by one or more processors to extend a base sequence, that includes a start value and an end value, into an extended preamble, where the extended preamble includes the base sequence, a first set of one or more values that precede the base sequence, and a second set of one or more values that follow the base sequence, and where the first set of one or more values are based on the start value of the base sequence, and the second set of one or more values are based on the end value of the base sequence and transmit, via a set of multiple time resources, a forward link transmission including the extended preamble to an A-IoT device, where the set of multiple time resources includes a first set of one or more boundary resources, a second set of one or more boundary resources, and a set of multiple intervening resources that are temporally between the first set of one or more boundary resources and the second set of one or more boundary resources, and where the base sequence is included in the forward link transmission and transmitted via the set of multiple intervening resources, where the first set of one or more values are included in the forward link transmission and transmitted via the first set of one or more boundary resources, and the second set of one or more values are included in the forward link transmission and transmitted via the second set of one or more boundary resources.

In some examples of the method, network entities, and non-transitory computer-readable medium described herein, the first set of one or more values includes one or more dummy values that immediately precede, and may be adjacent to, the start value of the base sequence and the one or more dummy values may be equal to the start value.

In some examples of the method, network entities, and non-transitory computer-readable medium described herein, the forward link transmission includes a CW signal and the first set of one or more values includes an AGC value that immediately precedes, and may be adjacent to, the one or more dummy values.

In some examples of the method, network entities, and non-transitory computer-readable medium described herein, the AGC value may be different than the start value. In some examples of the method, network entities, and non-transitory computer-readable medium described herein, the second set of one or more values includes one or more dummy values that immediately follow, and may be adjacent to, the end value of the base sequence and the one or more dummy values may be equal to the end value.

In some examples of the method, network entities, and non-transitory computer-readable medium described herein, the set of multiple time resources include OFDM symbols, OFDM samples, or any combination thereof, and the set of multiple intervening resources include a first set of one or more OFDM symbols, and the first set of one or more boundary resources and the second set of one or more boundary resources include respective sets of one or more OFDM symbols or respective portions of one or more OFDM symbols.

In some examples of the method, network entities, and non-transitory computer-readable medium described herein, the respective sets of one or more OFDM symbols or the respective portions of one or more OFDM symbols include one or more OFDM samples. In some examples of the method, network entities, and non-transitory computer-readable medium described herein, the one or more OFDM samples may be dummy samples.

In some examples of the method, network entities, and non-transitory computer-readable medium described herein, the forward link transmission includes Manchester encoded data and the Manchester encoded data immediately follows, and may be adjacent to, the second set of one or more values.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support an extended preamble for remote-to-device (R2D) communications in accordance with one or more aspects of the present disclosure.

FIG. 3 shows an example of a process flow that supports an extended preamble for R2D communications in accordance with one or more aspects of the present disclosure.

FIGS. 4 and 5 show block diagrams of devices that support an extended preamble for R2D communications in accordance with one or more aspects of the present disclosure.

FIG. 6 shows a block diagram of a communications manager that supports an extended preamble for R2D communications in accordance with one or more aspects of the present disclosure.

FIG. 7 shows a diagram of a system including a device that supports an extended preamble for R2D communications in accordance with one or more aspects of the present disclosure.

FIGS. 8 and 9 show block diagrams of devices that support an extended preamble for R2D communications in accordance with one or more aspects of the present disclosure.

FIG. 10 shows a block diagram of a communications manager that supports an extended preamble for R2D communications in accordance with one or more aspects of the present disclosure.

FIG. 11 shows a diagram of a system including a device that supports an extended preamble for R2D communications in accordance with one or more aspects of the present disclosure.

FIGS. 12 and 13 show flowcharts illustrating methods that support an extended preamble for R2D communications in accordance with one or more aspects of the present disclosure.

### DETAILED DESCRIPTION

Some wireless communications system may deploy ambient internet of things (A-IoT) devices for remote-to-device (R2D) communications. In some examples, an A-IoT device may not have its own power source and may receive power from transmissions by other devices, or from the environment. A-IoT devices may be referred to as energy harvesting wireless devices. A radio frequency (RF) reader (e.g., source device), such as a transmitter user equipment (UE), a network entity, or other wireless device, may transmit a continuous wave (CW) signal to the A-IoT device. The A-IoT device may harvest energy, store energy, or both, from the CW signal. An example of the A-IoT device may be a radio frequency identification tag (RFID).

In some examples, the A-IoT device may include an energy storage. The energy storage may power a local clock of the A-IoT device. In some examples, the local clock may be associated with an error. For example, the local clock may be relatively slow based on the A-IoT device utilizing relatively low-cost components. In some examples, the RF reader may assume the A-IoT device operates in an asynchronous mode. Based on A-IoT device operating in the asynchronous mode, the RF reader may transmit a preamble in a forward link to the A-IoT device. The preamble may enable the A-IoT device to obtain an initial timing estimate (e.g., to successfully receive and decode information in the forward link). However, the local clock error of the A-IoT device may degrade performance for successfully detecting and obtaining the preamble. Accordingly, it may be desirable to enhance preamble detection performance for the A-IoT device.

The systems, methods, and techniques described herein enable enhanced preamble detection performance based on the A-IoT device receiving an extended preamble (e.g., a start indicator part) that includes dummy resources. For example, the RF reader may extend a preamble of the forward link (e.g., a reader-to-device (R2D) transmission) with one or more dummy samples or one or more dummy symbols to compensate for the local clock error of the A-IoT device. In some examples, the extended preamble transmission may be preceded by a CW transmission (e.g., a wireless power charging signal). In such examples, the A-IoT device may receive an automatic gain control (AGC) value in the extended preamble. The AGC value may enable the A-IoT device to adjust a comparator threshold for receiving information in the forward link.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to an extended preamble for remote-to-device communications.

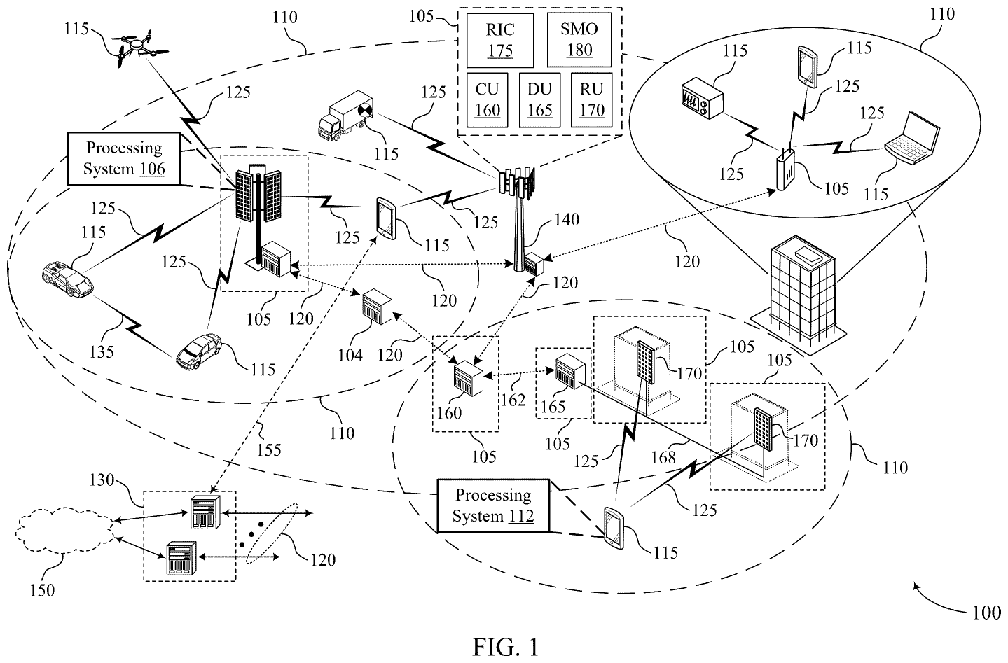

FIG. 1 shows an example of a wireless communications system 100 that supports an extended preamble for R2D communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RTRIC), a Non-Real Time RIC (Non-RTRIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IM S), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless communications systems 100 may deploy A-IoT devices for R2D communications. In some examples, an A-IoT device may not have its own power source and may receive power from transmissions by other devices, or from the environment. A-IoT devices may be referred to as energy harvesting wireless devices. An RF reader (e.g., source device), such as a UE 115, a network entity 105, or other wireless device, may transmit a continuous wave signal to the A-IoT device. The A-IoT device may harvest energy, store energy, or both, from the CW signal. An example of the A-IoT device may be a RFID tag.

In some examples, the A-IoT device may include an energy storage. The energy storage may power a local clock of the A-IoT device. In some examples, the local clock may be associated with an error. For example, the local clock may be relatively slow based on the A-IoT device utilizing relatively low-cost components. In some examples, the RF reader may assume the A-IoT device operates in an asynchronous mode. Based on A-IoT device operating in the asynchronous mode, the RF reader may transmit a preamble in a forward link to the A-IoT device (e.g., via an R2D transmission). The preamble may enable the A-IoT device to obtain an initial timing estimate (e.g., to successfully receive and decode information in the forward link). However, the local clock error of the A-IoT device may degrade performance for successfully detecting and obtaining the preamble. Accordingly, it may be desirable to enhance preamble detection performance for the A-IoT device.

The wireless communications system 100 may enable enhanced preamble detection performance based on the A-IoT device receiving an extended preamble that includes dummy resources. For example, the RF reader (e.g., a network entity 105) may extend a preamble of the forward link with one or more dummy samples or one or more dummy symbols to compensate for the local clock error of the A-IoT device. In some examples, the extended preamble transmission may be preceded by a CW transmission (e.g., a wireless power charging signal). In such examples, the A-IoT device may receive an AGC value in the extended preamble. The AGC value may enable the A-IoT device to adjust a comparator threshold for receiving information in the forward link.

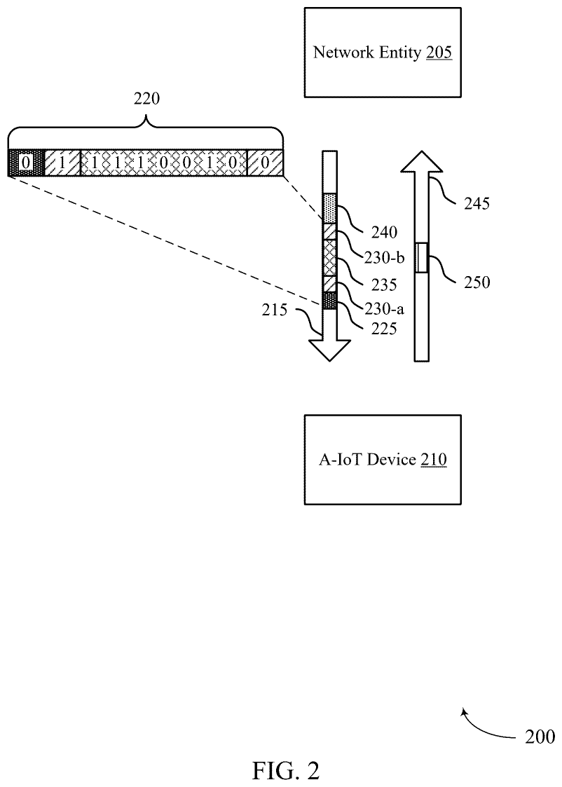

FIG. 2 shows an example of a wireless communications system 200 that supports an extended preamble for R2D communications in accordance with one or more aspects of the present disclosure. The wireless communications system 200 may implement aspects of or may be implemented by aspects of the wireless communications system 100. For example, the wireless communications system 200 includes a network entity 205, which may be an example of a first network entity (e.g., a UE 115) or a second network entity 105 as described herein.

The wireless communications system 200 may include an A-IoT device 210 (e.g., an energy harvesting network entity). In some examples, systems that support communications (e.g., the wireless communications system 100 or 200) between the network entity 205 and the A-IoT device 210 may be referred to as RFID systems, A-IoT systems, or both. Further, while the wireless communications system 200 illustrates communications between the network entity 205 and the A-IoT device 210, it is understood that the communications described herein may happen between the A-IoT device 210 and any type of network entity (e.g., a network entity 105, a UE 115, an access point (AP), among other examples).

The A-IoT device 210 may receive power from transmissions by the network entity 205, or from the environment. In some cases, the A-IoT device 210 may be an example of a passive radio device, a semi-passive radio device with energy harvesting and energy storing capabilities, an active radio device with energy harvesting and energy storing capabilities, an active radio device with a battery, or a combination thereof. In some examples, the A-IoT device may be one or more types of an RFID tag. In some cases, the A-IoT device 210 may include a battery or other energy storage device that may be rechargeable or may perform energy harvesting and store the harvested energy in energy storage circuits.

In some examples, the network entity 205 may be an RF reader (e.g., source device), such as a UE 115 or a network entity 105. For example, a network entity 205 may read or write information stored on the A-IoT device 210 and may provide energy to the A-IoT device 210 via a CW signal in a forward link 215 (e.g., an R2D transmission). The A-IoT device may harvest energy or store energy from the CW signal. In some examples, an information-bearing signal may be reflected from the A-IoT device 210 to the network entity 205. For example, the A-IoT device may transmit a response 250 in a backward link 245. In some examples, the backward link may be a backscatter link. In such examples, the network entity 205 may read the response 250 (e.g., reflected signal) to decode the information transmitted by the A-IoT device 210.

In some examples, the network entity 205 may assume the A-IoT device 210 operates in an asynchronous mode. For example, the A-IoT device 210 may wake-up and search for signals to communicate with the network entity 205 based on receiving (e.g., harvesting) the CW signal from the network entity 205 and not receive or store timing information associated with the network entity 205. Accordingly, the A-IoT device 210 may utilize a preamble 235 in the forward link 215 to obtain an initial timing estimate. For example, the A-IoT device 210 may use the preamble 235 as a reference sequence for signal detection. That is, a sequence of the preamble 235 may be known to the A-IoT device 210 before receiving the preamble 235 in the forward link 215. In some examples, the preamble 235 may refer to any signal transmitted prior to a query (e.g., an information request or transmission of data 240).

In some examples, the A-IoT device 210 may include a local clock powered by the battery or other energy storage device. The A-IoT device 210 may receive the CW signal based on the local clock. In some cases, the local clock may be associated with an error. For example, the local clock may be implemented via one or more relatively low-cost components, which may result in relatively more clock errors. In some examples, the local clock error may be associated with a relatively slower local clock (e.g., compared to a clock with less error).

The local clock error may result in the A-IoT device 210 incorrectly sampling the preamble 235 in the forward link 215. For example, the A-IoT device 210 may include one or more edge samples for a correlation window for receiving the preamble 235. That is, the A-IoT device 210 may include one or more samples before the preamble 235, one or more samples after the preamble 235, or both, which may degrade performance (e.g., corrupt symbols of data) for detecting the preamble 235 as well as any data 240 included in the forward link 215.

The techniques described herein enable enhanced preamble detection performance based on the A-IoT device 210 receiving an extended preamble 220. For example, the network entity 205 may extend the preamble 235 (e.g., a base preamble) with one or more boundary resources 230 to counteract the local clock erroneously sampling symbols immediately before, and immediately following, the preamble 235. As described herein, the extended preamble 220 may be referred to as a start indicator part (e.g., a start indicator part of an R2D transmission, such as the forward link 215). The one or more boundary resources 230 may include one or more OFDM symbols or portions of one or more OFDM symbols (e.g., one or more OFDM samples) that copy a first OFDM symbol of the preamble 235 or a last OFDM symbol of the preamble 235 (e.g., the boundary resources may include one or more dummy symbols). In some examples, the network entity 205 may extend the boundary symbols of the preamble 235 by a quantity of dummy samples to compensate for the clock error (e.g., copying a complete symbol may not be needed to compensate for the clock error). For example, the network entity 205 may extend the preamble 235 by half a symbol. Additionally, or alternatively, the network entity 205 may enable longer symbols for the boundary bits. For example, the network entity 205 may extend the preamble 235 by including a cyclic prefix, a symbol, or a fraction of a symbol (e.g., a sample) in the one or more boundary resources 230.

The A-IoT device 210 may receive one or more dummy values via the one or more boundary resources 230. In some examples, a first set of one or more boundary resources 230-a may immediately precede the start of the preamble resources. For example, the first set of one or more boundary resources 230-a may correspond to one or more dummy values based on the start of the sequence of the preamble 235. In some cases, the one or more dummy values received via the first set of one or more boundary resources 230-a may equal the start value of the preamble 235. For example, the dummy value may be ‘1’ based on a base preamble sequence being ‘1110010’ (e.g., the first value is 1, so the dummy value is 1). As described herein, a dummy value may refer to a value the A-IoT device 210 does not use for information detection purposes. For example, the dummy values may prevent erroneous sampling for the preamble 235, but may not provide additional information outside of the repeated values of the preamble 235. That is, the A-IoT device 210 may expect to receive the extended preamble 220 and may not attempt to use the dummy values for decoding information received in the forward link 215.

Additionally, or alternatively, a second set of one or more boundary resources 230-b may immediately follow the end of the base preamble resources. The second set of one or more boundary resources 230-b may correspond to one or more dummy values based on the end of the preamble 235. In some cases, the one or more dummy values received via the second set of one or more boundary resources 230-b may equal the end value of the preamble 235. For example, the dummy value may be ‘0’ based on the base preamble sequence being ‘1110010’ (e.g., the end value is 0, so the dummy value is 0).

In some examples, the extended preamble 220 may include one or more AGC values 225. In other examples, the one or more AGC values 225 may be transmitted before the extended preamble 220. In some cases, the preamble 235 may be preceded by a CW transmission (e.g., a wireless power charging signal). The A-IoT device 210 may sample a portion of the CW transmission to estimate a background noise of the forward link 215. The A-IoT device may use the samples to set a comparator threshold. For example, the A-IoT device 210 may use the comparator threshold to determine which bit is zero and which bit is one (e.g., based on a power of the signal).

In some examples, the one or more AGC values 225 may enable the A-IoT device 210 to determine the comparator threshold more accurately. For example, the A-IoT device 210 may use the one or more AGC values 225 as a reference for the comparator threshold based on the one or more AGC values 225 being different than the start value of the preamble 235 (e.g., and thus different than the first set of one or more values received via the first set of one or more boundary resources 230-a). For example, an AGC value may be ‘0’ based on the base preamble sequence being ‘1110010’ (e.g., the one or more AGC values may be a bitwise complement to the start value). The A-IoT device 210 may set the comparator threshold more accurately and distinguish the preamble sequence values relatively easier based on the AGC values being different than the start value of the preamble 235. In some examples, the A-IoT device may also use the AGC values 225 to know if the upcoming values in the preamble will be 0 or 1.

The extended preamble 220 may enable the A-IoT device 210 to detect the preamble 235 more effectively. In some examples, the extended preamble 220 may support an integrity of the data 240 that follows the extended preamble 220. For example, the A-IoT device 210 may not sample one or more symbols of the data 240 based on the dummy symbols between the preamble 235 and the data 240 (e.g., based on the second set of one or more boundary resources 230-b). In some examples, the data 240 may be encoded via a Manchester coding scheme. In Manchester coding, a bit may be represented by two levels of a signal. For example, a ‘0’ may be conveyed via a low-to-high signal transition within a bit interval and a ‘1’ may be conveyed via a high-to-low signal transition within a bit interval.

In some examples, the A-IoT device 210 may decode the data 240 more effectively based on receiving the one or more AGC values 225. Based on decoding the data 240, the A-IoT device 210 may transmit one or more transmissions in the backward link 245 to the network entity 205 based on receiving the signaling in the forward link 215. For example, the backward link 245 may include a response 250. In some examples, the response 250 may include information requested by the network entity 205 via the forward link 215 (e.g., via the data 240).

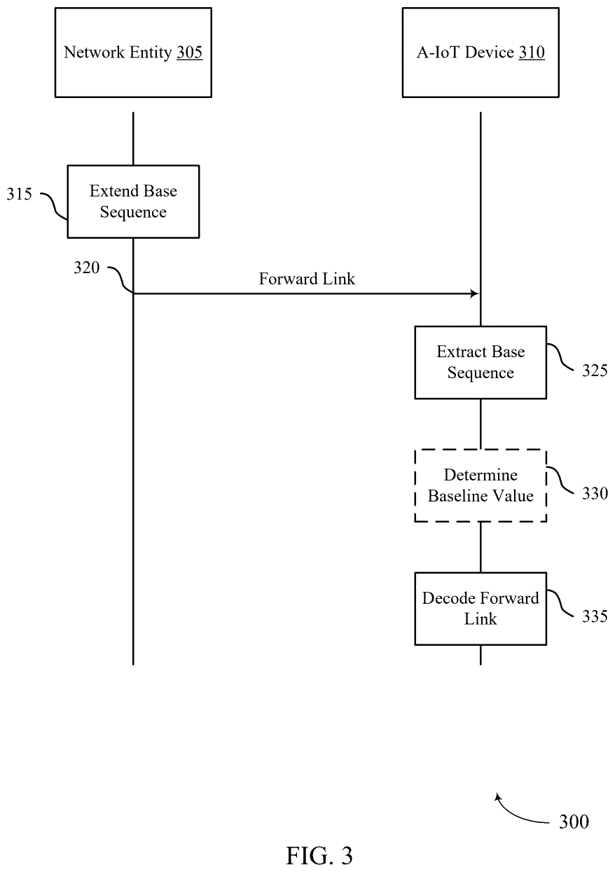

FIG. 3 shows an example of a process flow 300 that supports an extended preamble for R2D communications in accordance with one or more aspects of the present disclosure. The process flow 300 may be implemented by aspects of the wireless communications system 100 and 200. For example, a network entity 305 and an A-IoT device 310, which may be examples of a network entity 105 or an A-IoT device 210 as described herein, may perform aspects of the process flow 300. In the following description of the process flow 300, operations performed by the network entity 305 and the A-IoT device 310 may be performed in a different order than is shown. Some operations may be omitted from the process flow 300, and other operations may be added to the process flow 300. Further, although some operations or signaling may be shown to occur at different times for discussion purposes, these operations may occur at the same time.

At 315, the network entity 305 may extend a base sequence (e.g., a base preamble) that includes a start value and an end value into an extended preamble (e.g., a start indicator part). For example, the extended preamble may include the base sequence, a first set of one or more values that precede the base sequence and a second set of one or more values that follow the base sequence.

In some examples, the first set of one or more values are based on the start value of the base sequence. For example, the first set of one or more values may include one or more dummy values that are equal to the start value. In some cases, the one or more dummy values immediately precede, and are adjacent to, the start value of the base sequence. In some examples, the second set of one or more values are based on the end value of the base sequence. For example, the second set of one or more values may include one or more dummy values that are equal to the end value. In some cases, the one or more dummy values immediately follow, and are adjacent to, the end value of the base sequence.

At 320, the network entity 305 may transmit a forward link transmission (e.g., an R2D transmission) via multiple time resources to the A-IoT device 310. The forward link transmission may include the extended preamble. In some examples, the multiple time resources may include a first set of one or more boundary resources, a second set of one or more boundary resources, and multiple intervening resources that are temporally between the first set of one or more boundary resources and the second set of one or more boundary resources.

The multiple time resources may include OFDM symbols, OFDM samples, or any combination thereof. For example, the multiple intervening resources may include a first set of one or more OFDM symbols. In some examples, the first set of one or more boundary resources and the second set of one or more boundary resources may include respective sets of one or more OFDM symbols or respective portions of one or more OFDM symbols. In some cases, the respective sets of one or more OFDM symbols or the respective portions of one or more OFDM symbols may include one or more OFDM samples. In such cases, the one or more OFDM samples may be dummy samples.

In some examples, the network entity 305 may include the base sequence in the forward link transmission, and the network entity 305 may transmit the base sequence via the multiple intervening resources. In some examples, the network entity 305 may include the first set of one or more values in the forward link transmission and the second set of one or more values in the forward link transmission. In such examples, the network entity may transmit the first set of one or more values and the second set of one or more values via the first set of one or more boundary resources and the second set of one or more boundary resources, respectively. In some aspects, the forward link transmission may include Manchester encoded data that immediately follows, and is adjacent to, the second set of one or more values.

Additionally, or alternatively, the network entity 305 may include a CW signal. In such cases, the first set of one or more values may include an AGC value that immediately precedes, and is adjacent to, the one or more dummy values. In some examples, the AGC value may be different than the start value (e.g., or the one or more dummy values).

At 325, the A-IoT device 310 may extract the base sequence from the extended preamble. For example, the A-IoT device 310 may ignore the dummy values from the first set of one or more values and the second set of one or more values. In some examples, at 330, the A-IoT device 310 may determine a baseline value (e.g., a comparator threshold) for a digital high (e.g., a ‘1’) or a digital low (e.g., ‘0’) based on receiving the AGC value.

At 335, the A-IoT device 310 may decode a remainder of the forward link transmission based on extracting the base sequence from the extended preamble. For example, the remainder may include the Manchester encoded data. In some examples, the A-IoT device 310 may decode the remainder based on the baseline value.

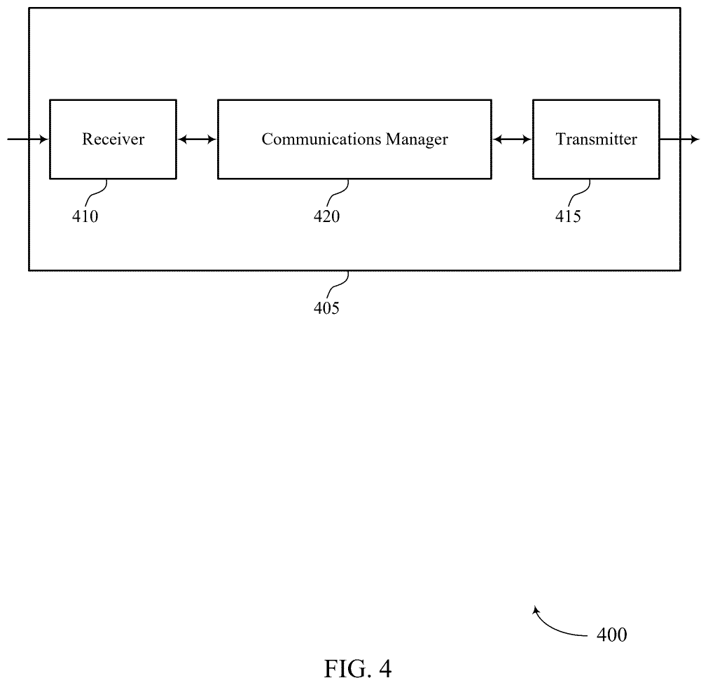

FIG. 4 shows a block diagram 400 of a device 405 that supports an extended preamble for R2D communications in accordance with one or more aspects of the present disclosure. The device 405 may be an example of aspects of a first network entity (e.g., UE 115) or A-IoT device (e.g., the A-IoT device 210) as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to an extended preamble for R2D communications). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to an extended preamble for R2D communications). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of an extended preamble for R2D communications as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an A SIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for receiving, via a set of multiple time resources, a forward link transmission including an extended preamble, where the set of multiple time resources includes a first set of one or more boundary resources, a second set of one or more boundary resources, and a set of multiple intervening resources that are temporally between the first set of one or more boundary resources and the second set of one or more boundary resources, and where the extended preamble includes a base sequence with a start value and an end value, where the base sequence is included in the forward link transmission and is received via the set of multiple intervening resources, where the extended preamble includes a first set of one or more values received via the first set of one or more boundary resources and a second set of one or more values received via the second set of one or more boundary resources, where the first set of one or more values are based on the start value of the base sequence, and the second set of one or more values are based on the end value of the base sequence. The communications manager 420 is capable of, configured to, or operable to support a means for extracting the base sequence from the extended preamble. The communications manager 420 is capable of, configured to, or operable to support a means for decoding a remainder of the forward link transmission based on extraction of the base sequence from the extended preamble.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources, among other examples.

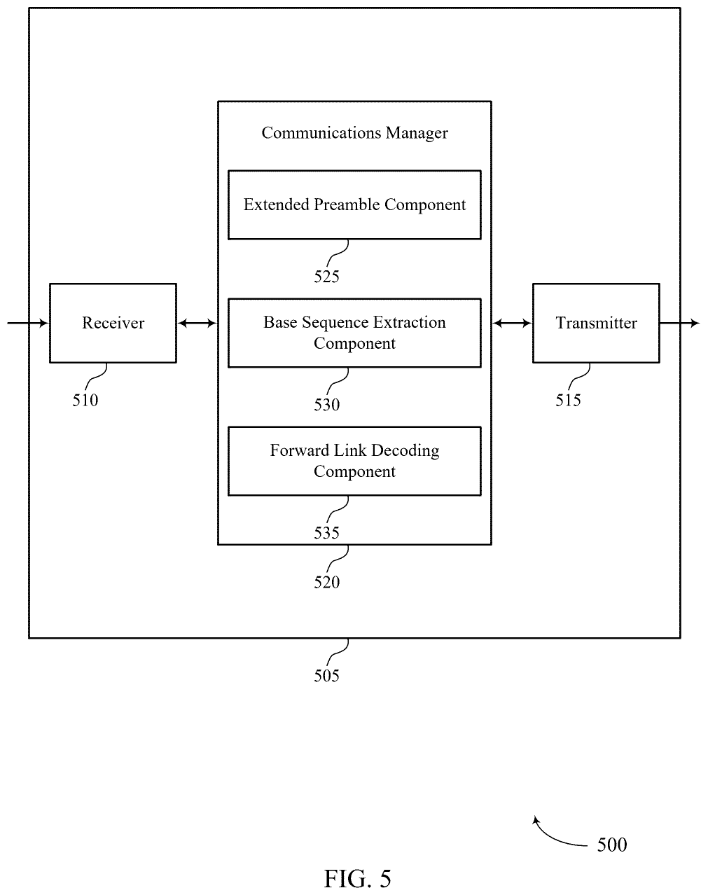

FIG. 5 shows a block diagram 500 of a device 505 that supports an extended preamble for R2D communications in accordance with one or more aspects of the present disclosure. The device 505 may be an example of aspects of a device 405 or a first network entity (e.g., a UE 115) or an A-IoT device (e.g., the A-IoT device 210) as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to an extended preamble for R2D communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to an extended preamble for R2D communications). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of an extended preamble for R2D communications as described herein. For example, the communications manager 520 may include an extended preamble component 525, a base sequence extraction component 530, a forward link decoding component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The extended preamble component 525 is capable of, configured to, or operable to support a means for receiving, via a set of multiple time resources, a forward link transmission including an extended preamble, where the set of multiple time resources includes a first set of one or more boundary resources, a second set of one or more boundary resources, and a set of multiple intervening resources that are temporally between the first set of one or more boundary resources and the second set of one or more boundary resources, and where the extended preamble includes a base sequence with a start value and an end value, where the base sequence is included in the forward link transmission and is received via the set of multiple intervening resources, where the extended preamble includes a first set of one or more values received via the first set of one or more boundary resources and a second set of one or more values received via the second set of one or more boundary resources, where the first set of one or more values are based on the start value of the base sequence, and the second set of one or more values are based on the end value of the base sequence. The base sequence extraction component 530 is capable of, configured to, or operable to support a means for extracting the base sequence from the extended preamble. The forward link decoding component 535 is capable of, configured to, or operable to support a means for decoding a remainder of the forward link transmission based on extraction of the base sequence from the extended preamble.

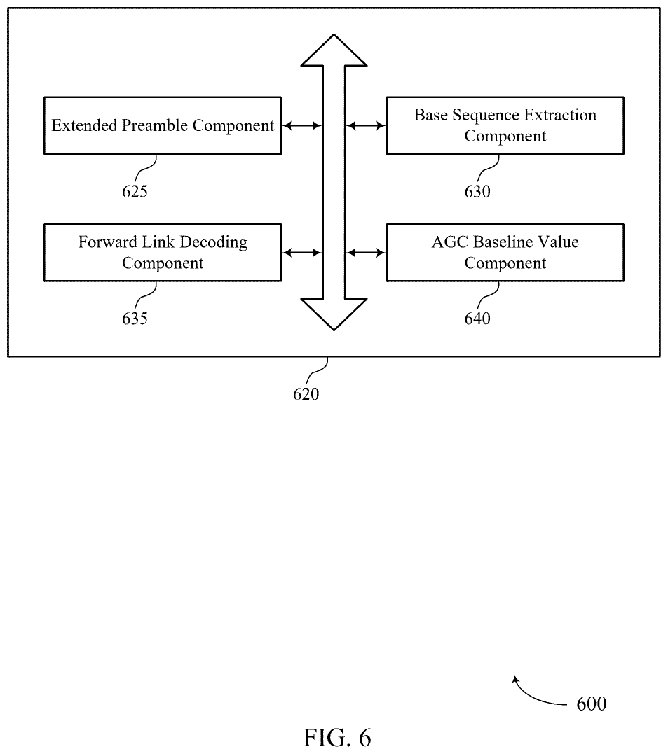

FIG. 6 shows a block diagram 600 of a communications manager 620 that supports an extended preamble for R2D communications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of an extended preamble for R2D communications as described herein. For example, the communications manager 620 may include an extended preamble component 625, a base sequence extraction component 630, a forward link decoding component 635, an AGC baseline value component 640, or any combination thereof. Each of these components, or components or subcomponents thereof (e.g., one or more processors, one or more memories), may communicate, directly or indirectly, with one another (e.g., via one or more buses).

The extended preamble component 625 is capable of, configured to, or operable to support a means for receiving, via a set of multiple time resources, a forward link transmission including an extended preamble, where the set of multiple time resources includes a first set of one or more boundary resources, a second set of one or more boundary resources, and a set of multiple intervening resources that are temporally between the first set of one or more boundary resources and the second set of one or more boundary resources, and where the extended preamble includes a base sequence with a start value and an end value, where the base sequence is included in the forward link transmission and is received via the set of multiple intervening resources, where the extended preamble includes a first set of one or more values received via the first set of one or more boundary resources and a second set of one or more values received via the second set of one or more boundary resources, where the first set of one or more values are based on the start value of the base sequence, and the second set of one or more values are based on the end value of the base sequence. The base sequence extraction component 630 is capable of, configured to, or operable to support a means for extracting the base sequence from the extended preamble. The forward link decoding component 635 is capable of, configured to, or operable to support a means for decoding a remainder of the forward link transmission based on extraction of the base sequence from the extended preamble.

In some examples, the first set of one or more values includes one or more dummy values that immediately precede, and are adjacent to, the start value of the base sequence. In some examples, the one or more dummy values are equal to the start value.

In some examples, the forward link transmission includes a CW signal. In some examples, the first set of one or more values includes an AGC value that immediately precedes, and is adjacent to, the one or more dummy values. In some examples, the AGC value is different than the start value.

In some examples, the AGC baseline value component 640 is capable of, configured to, or operable to support a means for determining a baseline value for a digital high value or a digital low value based on the AGC value, where decoding the remainder is based on the baseline value.

In some examples, the second set of one or more values includes one or more dummy values that immediately follow, and are adjacent to, the end value of the base sequence. In some examples, the one or more dummy values are equal to the end value.

In some examples, the set of multiple time resources include OFDM symbols, OFDM samples, or any combination thereof. In some examples, the set of multiple intervening resources include a first set of one or more OFDM symbols, and the first set of one or more boundary resources and the second set of one or more boundary resources include respective sets of one or more OFDM symbols or respective portions of one or more OFDM symbols.

In some examples, the respective sets of one or more OFDM symbols or the respective portions of one or more OFDM symbols include one or more OFDM samples. In some examples, the one or more OFDM samples are dummy samples.

In some examples, the forward link transmission includes Manchester encoded data. In some examples, the Manchester encoded data immediately follows, and is adjacent to, the second set of one or more values.

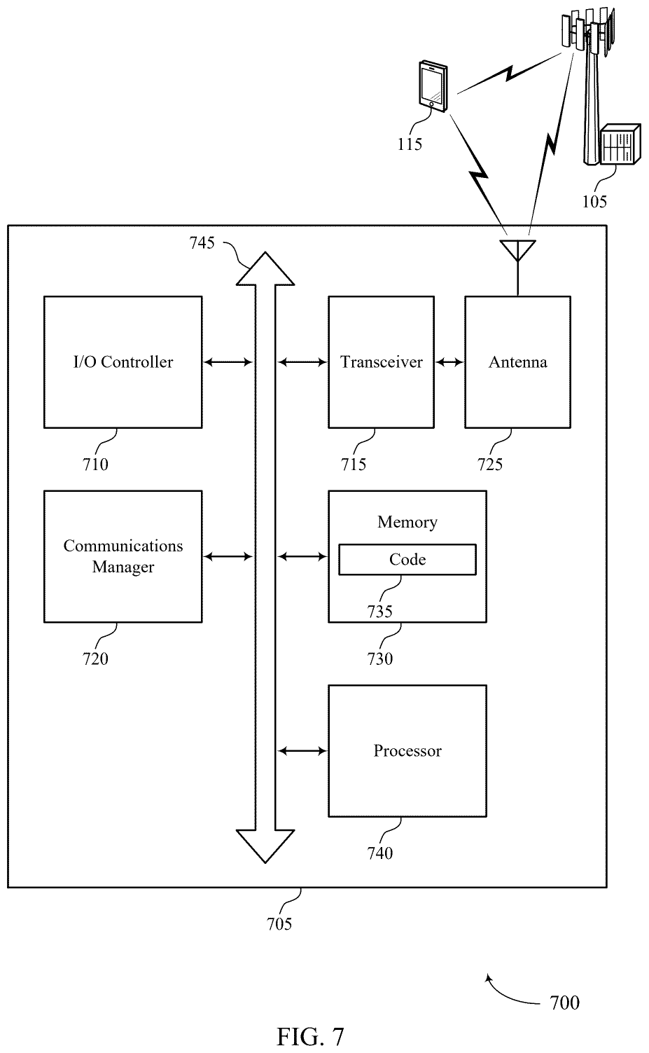

FIG. 7 shows a diagram of a system 700 including a device 705 that supports an extended preamble for R2D communications in accordance with one or more aspects of the present disclosure. The device 705 may be an example of or include components of a device 405, a device 505, a first network entity (e.g., UE 115), or an A-IoT device (e.g., the A-IoT device 210) as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more A SICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting an extended preamble for R2D communications). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

For example, the communications manager 720 is capable of, configured to, or operable to support a means for receiving, via a set of multiple time resources, a forward link transmission including an extended preamble, where the set of multiple time resources includes a first set of one or more boundary resources, a second set of one or more boundary resources, and a set of multiple intervening resources that are temporally between the first set of one or more boundary resources and the second set of one or more boundary resources, and where the extended preamble includes a base sequence with a start value and an end value, where the base sequence is included in the forward link transmission and is received via the set of multiple intervening resources, where the extended preamble includes a first set of one or more values received via the first set of one or more boundary resources and a second set of one or more values received via the second set of one or more boundary resources, where the first set of one or more values are based on the start value of the base sequence, and the second set of one or more values are based on the end value of the base sequence. The communications manager 720 is capable of, configured to, or operable to support a means for extracting the base sequence from the extended preamble. The communications manager 720 is capable of, configured to, or operable to support a means for decoding a remainder of the forward link transmission based on extraction of the base sequence from the extended preamble.

By including or configuring the communications manager 720 in accordance with examples as described herein, the device 705 may support techniques for improved communication reliability, reduced latency, more efficient utilization of communication resources, and improved coordination between devices, among other examples.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of an extended preamble for R2D communications as described herein, or the at least one processor 740 and the at least one memory 730 may be otherwise configured to, individually or collectively, perform or support such operations.

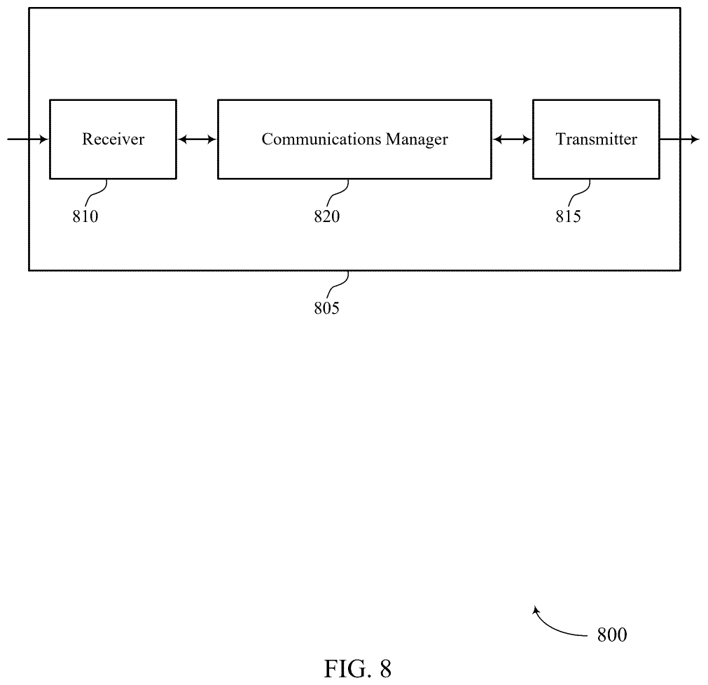

FIG. 8 shows a block diagram 800 of a device 805 that supports an extended preamble for R2D communications in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of an extended preamble for R2D communications as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication performed in accordance with examples as disclosed herein. For example, the communications manager 820 is capable of, configured to, or operable to support a means for extending a base sequence, that includes a start value and an end value, into an extended preamble, where the extended preamble includes the base sequence, a first set of one or more values that precede the base sequence, and a second set of one or more values that follow the base sequence, and where the first set of one or more values are based on the start value of the base sequence, and the second set of one or more values are based on the end value of the base sequence. The communications manager 820 is capable of, configured to, or operable to support a means for transmitting, via a set of multiple time resources, a forward link transmission including the extended preamble to an ambient internet-of-things (A-IoT) device, where the set of multiple time resources includes a first set of one or more boundary resources, a second set of one or more boundary resources, and a set of multiple intervening resources that are temporally between the first set of one or more boundary resources and the second set of one or more boundary resources, and where the base sequence is included in the forward link transmission and transmitted via the set of multiple intervening resources, where the first set of one or more values are included in the forward link transmission and transmitted via the first set of one or more boundary resources, and the second set of one or more values are included in the forward link transmission and transmitted via the second set of one or more boundary resources.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources, among other examples.

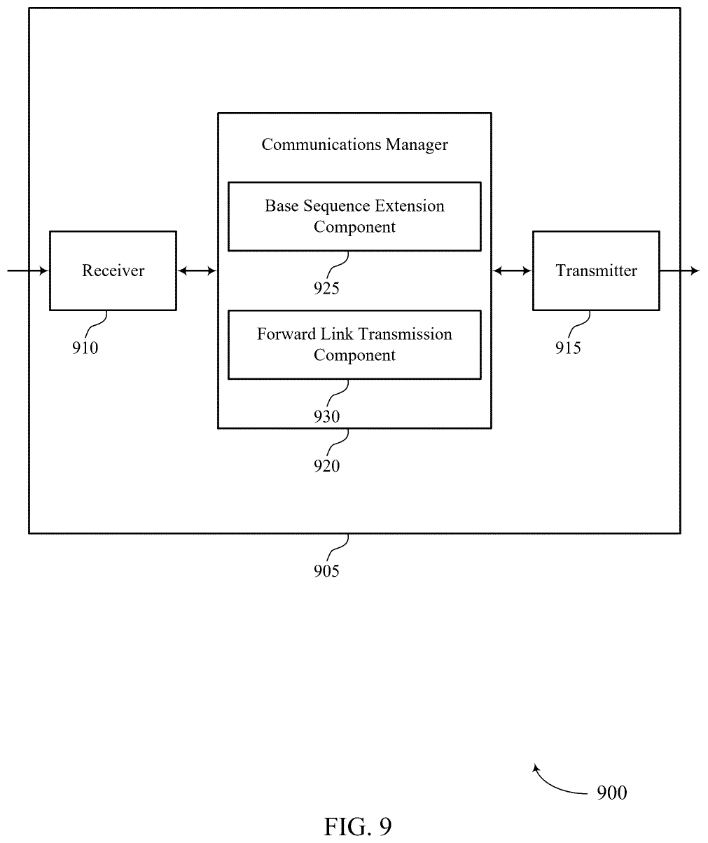

FIG. 9 shows a block diagram 900 of a device 905 that supports an extended preamble for R2D communications in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of an extended preamble for R2D communications as described herein. For example, the communications manager 920 may include a base sequence extension component 925 a forward link transmission component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication performed in accordance with examples as disclosed herein. The base sequence extension component 925 is capable of, configured to, or operable to support a means for extending a base sequence, that includes a start value and an end value, into an extended preamble, where the extended preamble includes the base sequence, a first set of one or more values that precede the base sequence, and a second set of one or more values that follow the base sequence, and where the first set of one or more values are based on the start value of the base sequence, and the second set of one or more values are based on the end value of the base sequence. The forward link transmission component 930 is capable of, configured to, or operable to support a means for transmitting, via a set of multiple time resources, a forward link transmission including the extended preamble to an ambient internet-of-things (A-IoT) device, where the set of multiple time resources includes a first set of one or more boundary resources, a second set of one or more boundary resources, and a set of multiple intervening resources that are temporally between the first set of one or more boundary resources and the second set of one or more boundary resources, and where the base sequence is included in the forward link transmission and transmitted via the set of multiple intervening resources, where the first set of one or more values are included in the forward link transmission and transmitted via the first set of one or more boundary resources, and the second set of one or more values are included in the forward link transmission and transmitted via the second set of one or more boundary resources.

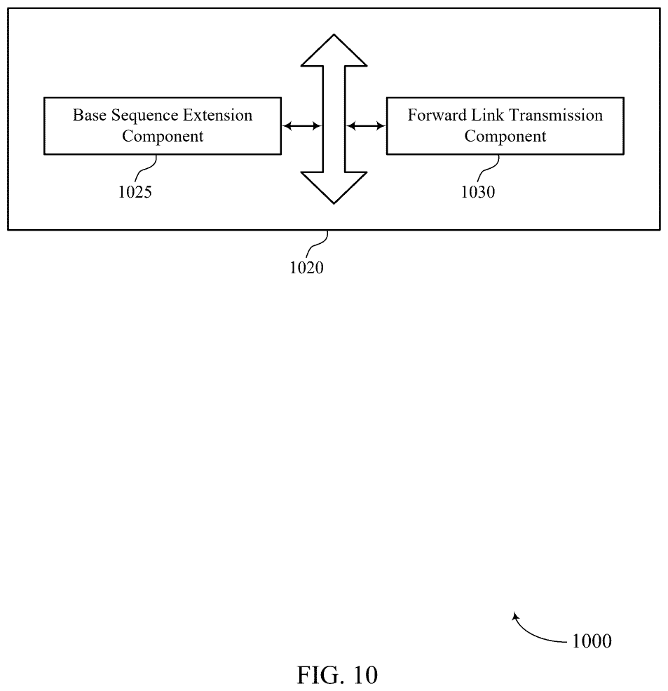

FIG. 10 shows a block diagram 1000 of a communications manager 1020 that supports an extended preamble for R2D communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of an extended preamble for R2D communications as described herein. For example, the communications manager 1020 may include a base sequence extension component 1025 a forward link transmission component 1030, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication performed in accordance with examples as disclosed herein. The base sequence extension component 1025 is capable of, configured to, or operable to support a means for extending a base sequence, that includes a start value and an end value, into an extended preamble, where the extended preamble includes the base sequence, a first set of one or more values that precede the base sequence, and a second set of one or more values that follow the base sequence, and where the first set of one or more values are based on the start value of the base sequence, and the second set of one or more values are based on the end value of the base sequence. The forward link transmission component 1030 is capable of, configured to, or operable to support a means for transmitting, via a set of multiple time resources, a forward link transmission including the extended preamble to an ambient internet-of-things (A-IoT) device, where the set of multiple time resources includes a first set of one or more boundary resources, a second set of one or more boundary resources, and a set of multiple intervening resources that are temporally between the first set of one or more boundary resources and the second set of one or more boundary resources, and where the base sequence is included in the forward link transmission and transmitted via the set of multiple intervening resources, where the first set of one or more values are included in the forward link transmission and transmitted via the first set of one or more boundary resources, and the second set of one or more values are included in the forward link transmission and transmitted via the second set of one or more boundary resources.

In some examples, the first set of one or more values includes one or more dummy values that immediately precede, and are adjacent to, the start value of the base sequence. In some examples, the one or more dummy values are equal to the start value.

In some examples, the forward link transmission includes a CW signal. In some examples, the first set of one or more values includes an AGC value that immediately precedes, and is adjacent to, the one or more dummy values. In some examples, the AGC value is different than the start value.

In some examples, the second set of one or more values includes one or more dummy values that immediately follow, and are adjacent to, the end value of the base sequence. In some examples, the one or more dummy values are equal to the end value.

In some examples, the set of multiple time resources include OFDM symbols, OFDM samples, or any combination thereof, and. In some examples, the set of multiple intervening resources include a first set of one or more OFDM symbols, and the first set of one or more boundary resources and the second set of one or more boundary resources include respective sets of one or more OFDM symbols or respective portions of one or more OFDM symbols.

In some examples, the respective sets of one or more OFDM symbols or the respective portions of one or more OFDM symbols include one or more OFDM samples. In some examples, the one or more OFDM samples are dummy samples.

In some examples, the forward link transmission includes Manchester encoded data. In some examples, the Manchester encoded data immediately follows, and is adjacent to, the second set of one or more values.

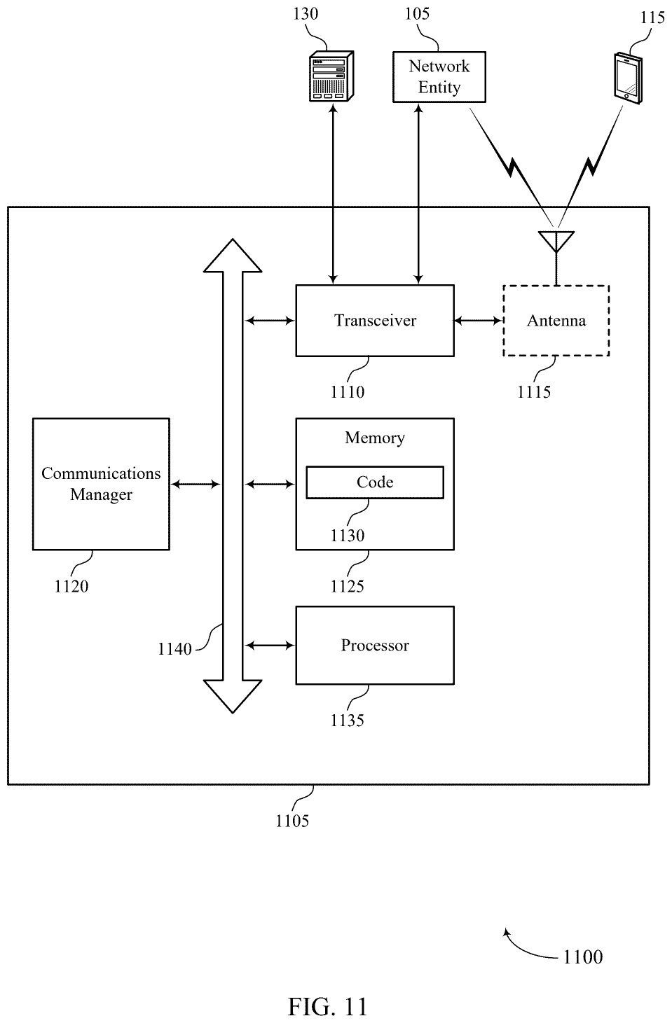

FIG. 11 shows a diagram of a system 1100 including a device 1105 that supports an extended preamble for R2D communications in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more A SICs, one or more FPGA s, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting an extended preamble for R2D communications). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communication performed in accordance with examples as disclosed herein. For example, the communications manager 1120 is capable of, configured to, or operable to support a means for extending a base sequence, that includes a start value and an end value, into an extended preamble, where the extended preamble includes the base sequence, a first set of one or more values that precede the base sequence, and a second set of one or more values that follow the base sequence, and where the first set of one or more values are based on the start value of the base sequence, and the second set of one or more values are based on the end value of the base sequence. The communications manager 1120 is capable of, configured to, or operable to support a means for transmitting, via a set of multiple time resources, a forward link transmission including the extended preamble to an ambient internet-of-things (A-IoT) device, where the set of multiple time resources includes a first set of one or more boundary resources, a second set of one or more boundary resources, and a set of multiple intervening resources that are temporally between the first set of one or more boundary resources and the second set of one or more boundary resources, and where the base sequence is included in the forward link transmission and transmitted via the set of multiple intervening resources, where the first set of one or more values are included in the forward link transmission and transmitted via the first set of one or more boundary resources, and the second set of one or more values are included in the forward link transmission and transmitted via the second set of one or more boundary resources.

By including or configuring the communications manager 1120 in accordance with examples as described herein, the device 1105 may support techniques for improved communication reliability, reduced latency, more efficient utilization of communication resources, and improved coordination between devices, among other examples.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of an extended preamble for R2D communications as described herein, or the at least one processor 1135 and the at least one memory 1125 may be otherwise configured to, individually or collectively, perform or support such operations.

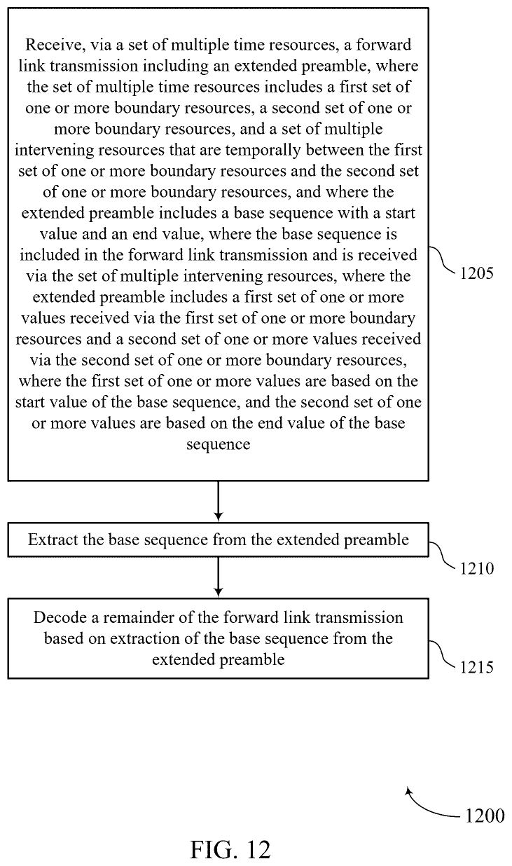

FIG. 12 shows a flowchart illustrating a method 1200 that supports an extended preamble for R2D communications in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, via a set of multiple time resources, a forward link transmission including an extended preamble, where the set of multiple time resources includes a first set of one or more boundary resources, a second set of one or more boundary resources, and a set of multiple intervening resources that are temporally between the first set of one or more boundary resources and the second set of one or more boundary resources, and where the extended preamble includes a base sequence with a start value and an end value, where the base sequence is included in the forward link transmission and is received via the set of multiple intervening resources, where the extended preamble includes a first set of one or more values received via the first set of one or more boundary resources and a second set of one or more values received via the second set of one or more boundary resources, where the first set of one or more values are based on the start value of the base sequence, and the second set of one or more values are based on the end value of the base sequence. The operations of 1205 may be performed in accordance with examples as disclosed herein. In some examples, aspects of the operations of 1205 may be performed by an extended preamble component 625 as described with reference to FIG. 6.

At 1210, the method may include extracting the base sequence from the extended preamble. The operations of 1210 may be performed in accordance with examples as disclosed herein. In some examples, aspects of the operations of 1210 may be performed by a base sequence extraction component 630 as described with reference to FIG. 6.

At 1215, the method may include decoding a remainder of the forward link transmission based on extraction of the base sequence from the extended preamble. The operations of 1215 may be performed in accordance with examples as disclosed herein. In some examples, aspects of the operations of 1215 may be performed by a forward link decoding component 635 as described with reference to FIG. 6.

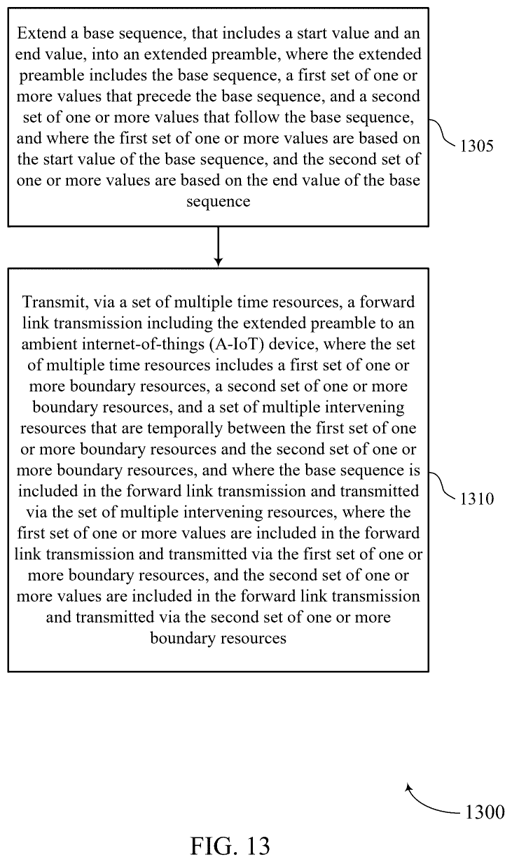

FIG. 13 shows a flowchart illustrating a method 1300 that supports an extended preamble for R2D communications in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include extending a base sequence, that includes a start value and an end value, into an extended preamble, where the extended preamble includes the base sequence, a first set of one or more values that precede the base sequence, and a second set of one or more values that follow the base sequence, and where the first set of one or more values are based on the start value of the base sequence, and the second set of one or more values are based on the end value of the base sequence. The operations of 1305 may be performed in accordance with examples as disclosed herein. In some examples, aspects of the operations of 1305 may be performed by a base sequence extension component 1025 as described with reference to FIG. 10.

At 1310, the method may include transmitting, via a set of multiple time resources, a forward link transmission including the extended preamble to an ambient internet-of-things (A-IoT) device, where the set of multiple time resources includes a first set of one or more boundary resources, a second set of one or more boundary resources, and a set of multiple intervening resources that are temporally between the first set of one or more boundary resources and the second set of one or more boundary resources, and where the base sequence is included in the forward link transmission and transmitted via the set of multiple intervening resources, where the first set of one or more values are included in the forward link transmission and transmitted via the first set of one or more boundary resources, and the second set of one or more values are included in the forward link transmission and transmitted via the second set of one or more boundary resources. The operations of 1310 may be performed in accordance with examples as disclosed herein. In some examples, aspects of the operations of 1310 may be performed by a forward link transmission component 1030 as described with reference to FIG. 10.

The following provides an overview of aspects of the present disclosure:

Aspect 1: A method of wireless communication performed by an A-IoT device, comprising: receiving, via a plurality of time resources, a forward link transmission comprising an extended preamble, wherein the plurality of time resources includes a first set of one or more boundary resources, a second set of one or more boundary resources, and a plurality of intervening resources that are temporally between the first set of one or more boundary resources and the second set of one or more boundary resources, and wherein the extended preamble includes a base sequence with a start value and an end value, wherein the base sequence is included in the forward link transmission and is received via the plurality of intervening resources, wherein the extended preamble includes a first set of one or more values received via the first set of one or more boundary resources and a second set of one or more values received via the second set of one or more boundary resources, wherein the first set of one or more values are based on the start value of the base sequence, and the second set of one or more values are based on the end value of the base sequence; extracting the base sequence from the extended preamble; and decoding a remainder of the forward link transmission based on extraction of the base sequence from the extended preamble.

Aspect 2: The method of aspect 1, wherein the first set of one or more values includes one or more dummy values that immediately precede, and are adjacent to, the start value of the base sequence, the one or more dummy values are equal to the start value.

Aspect 3: The method of aspect 2, wherein the forward link transmission includes a CW signal, and the first set of one or more values includes an AGC value that immediately precedes, and is adjacent to, the one or more dummy values.

Aspect 4: The method of aspect 3, wherein the AGC value is different than the start value.

Aspect 5: The method of any of aspects 3 through 4, further comprising: determining a baseline value for a digital high value or a digital low value based on the AGC value, wherein decoding the remainder is based on the baseline value.

Aspect 6: The method of any of aspects 1 through 5, wherein the second set of one or more values includes one or more dummy values that immediately follow, and are adjacent to, the end value of the base sequence, the one or more dummy values are equal to the end value.

Aspect 7: The method of any of aspects 1 through 6, wherein the plurality of time resources include OFDM symbols, OFDM samples, or any combination thereof, and the plurality of intervening resources include a first set of one or more OFDM symbols, and the first set of one or more boundary resources and the second set of one or more boundary resources include respective sets of one or more OFDM symbols or respective portions of one or more OFDM symbols.

Aspect 8: The method of aspect 7, wherein the respective sets of one or more OFDM symbols or the respective portions of one or more OFDM symbols include one or more OFDM samples.

Aspect 9: The method of aspect 8, wherein the one or more OFDM samples are dummy samples.

Aspect 10: The method of any of aspects 1 through 9, wherein the forward link transmission includes Manchester encoded data, and the Manchester encoded data immediately follows, and is adjacent to, the second set of one or more values.

Aspect 11: A method for wireless communication performed by a network entity, comprising: extending a base sequence, that includes a start value and an end value, into an extended preamble, wherein the extended preamble includes the base sequence, a first set of one or more values that precede the base sequence, and a second set of one or more values that follow the base sequence, and wherein the first set of one or more values are based on the start value of the base sequence, and the second set of one or more values are based on the end value of the base sequence; and transmitting, via a plurality of time resources, a forward link transmission comprising the extended preamble to an A-IoT device, wherein the plurality of time resources includes a first set of one or more boundary resources, a second set of one or more boundary resources, and a plurality of intervening resources that are temporally between the first set of one or more boundary resources and the second set of one or more boundary resources, and wherein the base sequence is included in the forward link transmission and transmitted via the plurality of intervening resources, wherein the first set of one or more values are included in the forward link transmission and transmitted via the first set of one or more boundary resources, and the second set of one or more values are included in the forward link transmission and transmitted via the second set of one or more boundary resources.

Aspect 12: The method of aspect 11, wherein the first set of one or more values includes one or more dummy values that immediately precede, and are adjacent to, the start value of the base sequence, the one or more dummy values are equal to the start value.

Aspect 13: The method of aspect 12, wherein the forward link transmission includes a CW signal, and the first set of one or more values includes an AGC value that immediately precedes, and is adjacent to, the one or more dummy values.

Aspect 14: The method of aspect 13, wherein the AGC value is different than the start value.

Aspect 15: The method of any of aspects 11 through 14, wherein the second set of one or more values includes one or more dummy values that immediately follow, and are adjacent to, the end value of the base sequence, the one or more dummy values are equal to the end value.

Aspect 16: The method of any of aspects 11 through 15, wherein the plurality of time resources include OFDM symbols, OFDM samples, or any combination thereof, and the plurality of intervening resources include a first set of one or more OFDM symbols, and the first set of one or more boundary resources and the second set of one or more boundary resources include respective sets of one or more OFDM symbols or respective portions of one or more OFDM symbols.

Aspect 17: The method of aspect 16, wherein the respective sets of one or more OFDM symbols or the respective portions of one or more OFDM symbols include one or more OFDM samples.

Aspect 18: The method of any of aspects 16 through 17, wherein the one or more OFDM samples are dummy samples.

Aspect 19: The method of any of aspects 11 through 18, wherein the forward link transmission includes Manchester encoded data, and the Manchester encoded data immediately follows, and is adjacent to, the second set of one or more values.

Aspect 20: An A-IoT device comprising one or more memories storing processor-executable code, and one or more processors coupled with the one or more memories and individually or collectively operable to execute the code to cause the A-IoT device to perform a method of any of aspects 1 through 10.

Aspect 21: An A-IoT device comprising at least one means for performing a method of any of aspects 1 through 10.

Aspect 22: A non-transitory computer-readable medium storing code the code comprising instructions executable by one or more processors to perform a method of any of aspects 1 through 10.

Aspect 23: A network entity for wireless communication performed, comprising one or more memories storing processor-executable code, and one or more processors coupled with the one or more memories and individually or collectively operable to execute the code to cause the network entity to perform a method of any of aspects 11 through 19.

Aspect 24: A network entity for wireless communication performed, comprising at least one means for performing a method of any of aspects 11 through 19.

Aspect 25: A non-transitory computer-readable medium storing code for wireless communication performed, the code comprising instructions executable by one or more processors to perform a method of any of aspects 11 through 19.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UM B), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of One or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

Additionally, a “set” refers to one or more items unless specifically disclosed differently (e.g., a set of a plurality of items), and a “subset” refers to a non-empty portion that is less than a whole set unless specifically disclosed to the differently (e.g., a subset of zero or more items of the set one or more items).

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An ambient internet-of-things (A-IoT) device for wireless communication, comprising:
a processing system configured to:
receive, via a plurality of time resources, a forward link transmission comprising an extended preamble, wherein the plurality of time resources includes a first set of one or more boundary resources, a second set of one or more boundary resources, and a plurality of intervening resources that are temporally between the first set of one or more boundary resources and the second set of one or more boundary resources, and wherein the extended preamble includes a base sequence with a start value and an end value, wherein the base sequence is included in the forward link transmission and is received via the plurality of intervening resources, wherein the extended preamble includes a first set of one or more values received via the first set of one or more boundary resources and a second set of one or more values received via the second set of one or more boundary resources, wherein the first set of one or more values are based on the start value of the base sequence, and the second set of one or more values are based on the end value of the base sequence;
extract the base sequence from the extended preamble; and
decode a remainder of the forward link transmission based on extraction of the base sequence from the extended preamble.

2. The A-IoT device of claim 1, wherein the first set of one or more values includes one or more dummy values that immediately precede, and are adjacent to, the start value of the base sequence, wherein the one or more dummy values are equal to the start value.

3. The A-IoT device of claim 2, wherein the forward link transmission includes a continuous wave (CW) signal, and wherein the first set of one or more values includes an automatic gain control (AGC) value that immediately precedes, and is adjacent to, the one or more dummy values.

4. The A-IoT device of claim 3, wherein the AGC value is different than the start value.

5. The A-IoT device of claim 3, wherein the processing system is configured to:
determine a baseline value for a digital high value or a digital low value based on the AGC value, wherein, to decode the remainder, the processing system is configured to decode the remainder based on the baseline value.

6. The A-IoT device of claim 1, wherein the second set of one or more values includes one or more dummy values that immediately follow, and are adjacent to, the end value of the base sequence, wherein the one or more dummy values are equal to the end value.

7. The A-IoT device of claim 1, wherein the plurality of time resources include orthogonal frequency-division multiplexing (OFDM) symbols, OFDM samples, or any combination thereof, and wherein the plurality of intervening resources include a first set of one or more OFDM symbols, and the first set of one or more boundary resources and the second set of one or more boundary resources include respective sets of one or more OFDM symbols or respective portions of one or more OFDM symbols.

8. The A-IoT device of claim 7, wherein the respective sets of one or more OFDM symbols or the respective portions of one or more OFDM symbols include one or more OFDM samples.

9. The A-IoT device of claim 8, wherein the one or more OFDM samples are dummy samples.

10. The A-IoT device of claim 1, wherein the forward link transmission includes Manchester encoded data, and wherein the Manchester encoded data immediately follows, and is adjacent to, the second set of one or more values.

11. A method of wireless communication performed by an ambient internet-of-things (A-IoT) device, comprising:
receiving, via a plurality of time resources, a forward link transmission comprising an extended preamble, wherein the plurality of time resources includes a first set of one or more boundary resources, a second set of one or more boundary resources, and a plurality of intervening resources that are temporally between the first set of one or more boundary resources and the second set of one or more boundary resources, and wherein the extended preamble includes a base sequence with a start value and an end value, wherein the base sequence is included in the forward link transmission and is received via the plurality of intervening resources, wherein the extended preamble includes a first set of one or more values received via the first set of one or more boundary resources and a second set of one or more values received via the second set of one or more boundary resources, wherein the first set of one or more values are based on the start value of the base sequence, and the second set of one or more values are based on the end value of the base sequence;
extracting the base sequence from the extended preamble; and
decoding a remainder of the forward link transmission based on extraction of the base sequence from the extended preamble.

12. The method of claim 11, wherein the first set of one or more values includes one or more dummy values that immediately precede, and are adjacent to, the start value of the base sequence, wherein the one or more dummy values are equal to the start value.

13. The method of claim 12, wherein the forward link transmission includes a continuous wave (CW) signal, and wherein the first set of one or more values includes an automatic gain control (AGC) value that immediately precedes, and is adjacent to, the one or more dummy values.

14. The method of claim 13, wherein the AGC value is different than the start value.

15. The method of claim 13, further comprising:
determining a baseline value for a digital high value or a digital low value based on the AGC value, wherein decoding the remainder is based on the baseline value.

16. The method of claim 11, wherein the second set of one or more values includes one or more dummy values that immediately follow, and are adjacent to, the end value of the base sequence, wherein the one or more dummy values are equal to the end value.

17. The method of claim 11, wherein the plurality of time resources include orthogonal frequency-division multiplexing (OFDM) symbols, OFDM samples, or any combination thereof, and wherein the plurality of intervening resources include a first set of one or more OFDM symbols, and the first set of one or more boundary resources and the second set of one or more boundary resources include respective sets of one or more OFDM symbols or respective portions of one or more OFDM symbols.

18. The method of claim 17, wherein the respective sets of one or more OFDM symbols or the respective portions of one or more OFDM symbols include one or more OFDM samples.

19. The method of claim 18, wherein the one or more OFDM samples are dummy samples.

20. A network entity for wireless communication, comprising:
a processing system configured to:
extend a base sequence, that includes a start value and an end value, into an extended preamble, wherein the extended preamble includes the base sequence, a first set of one or more values that precede the base sequence, and a second set of one or more values that follow the base sequence, and wherein the first set of one or more values are based on the start value of the base sequence, and the second set of one or more values are based on the end value of the base sequence; and
transmit, via a plurality of time resources, a forward link transmission comprising the extended preamble to an ambient internet-of-things (A-IoT) device, wherein the plurality of time resources includes a first set of one or more boundary resources, a second set of one or more boundary resources, and a plurality of intervening resources that are temporally between the first set of one or more boundary resources and the second set of one or more boundary resources, and wherein the base sequence is included in the forward link transmission and transmitted via the plurality of intervening resources, wherein the first set of one or more values are included in the forward link transmission and transmitted via the first set of one or more boundary resources, and the second set of one or more values are included in the forward link transmission and transmitted via the second set of one or more boundary resources.

21. The network entity of claim 20, wherein the first set of one or more values includes one or more dummy values that immediately precede, and are adjacent to, the start value of the base sequence, wherein the one or more dummy values are equal to the start value.

22. The network entity of claim 21, wherein the forward link transmission includes a continuous wave (CW) signal, and wherein the first set of one or more values includes an automatic gain control (AGC) value that immediately precedes, and is adjacent to, the one or more dummy values.

23. The network entity of claim 22, wherein the AGC value is different than the start value.

24. The network entity of claim 20, wherein the second set of one or more values includes one or more dummy values that immediately follow, and are adjacent to, the end value of the base sequence, wherein the one or more dummy values are equal to the end value.

25. The network entity of claim 20, wherein the plurality of time resources include orthogonal frequency-division multiplexing (OFDM) symbols, OFDM samples, or any combination thereof, and wherein the plurality of intervening resources include a first set of one or more OFDM symbols, and the first set of one or more boundary resources and the second set of one or more boundary resources include respective sets of one or more OFDM symbols or respective portions of one or more OFDM symbols.

26. The network entity of claim 25, wherein the respective sets of one or more OFDM symbols or the respective portions of one or more OFDM symbols include one or more OFDM samples.

27. The network entity of claim 25, wherein the one or more OFDM samples are dummy samples.

28. The network entity of claim 20, wherein the forward link transmission includes Manchester encoded data, and wherein the Manchester encoded data immediately follows, and is adjacent to, the second set of one or more values.

29. A method of wireless communication performed by a network entity, comprising:
extending a base sequence, that includes a start value and an end value, into an extended preamble, wherein the extended preamble includes the base sequence, a first set of one or more values that precede the base sequence, and a second set of one or more values that follow the base sequence, and wherein the first set of one or more values are based on the start value of the base sequence, and the second set of one or more values are based on the end value of the base sequence; and
transmitting, via a plurality of time resources, a forward link transmission comprising the extended preamble to an ambient internet-of-things (A-IoT) device, wherein the plurality of time resources includes a first set of one or more boundary resources, a second set of one or more boundary resources, and a plurality of intervening resources that are temporally between the first set of one or more boundary resources and the second set of one or more boundary resources, and wherein the base sequence is included in the forward link transmission and transmitted via the plurality of intervening resources, wherein the first set of one or more values are included in the forward link transmission and transmitted via the first set of one or more boundary resources, and the second set of one or more values are included in the forward link transmission and transmitted via the second set of one or more boundary resources.

30. The method of claim 29, wherein the first set of one or more values includes one or more dummy values that immediately precede, and are adjacent to, the start value of the base sequence, wherein the one or more dummy values are equal to the start value.
